(19) United States
(12) Patent Application Publication
(10) Pub. No.: US 2017/0076312 A1
(43) Pub. Date: Mar. 16, 2017

(54) SYSTEM AND METHOD FOR RECOMMENDING OFFLINE PHYSICAL RETAIL OUTLETS TO USERS

(71) Applicant: Amit Sharma, Bangalore (IN)

(72) Inventors: Amit Sharma, Bangalore (IN); Amit Koshal, Vadodara (IN); Rishi Batra, New Delhi (IN)

(21) Appl. No.: 15/265,846

(22) Filed: Sep. 14, 2016

(30) Foreign Application Priority Data
Sep. 15, 2015 (IN) 3625/CHE/2015

(51) Int. Cl. G06Q 30/02; G06Q 20/32

(52) U.S. Cl. CPC G06Q 30/0224; G06Q 20/3223; G06Q 30/0223

(57) ABSTRACT

System and method for recommending items to a user of an electronic device are described. The system stores an inventory of commodities offered on sale by a plurality of predetermined offline physical retail outlets. The system extracts real time information corresponding to the user indicative of user intent to purchase at least one commodity offered on sale by the offline physical retail outlets listed with the system. The system also extracts historical information corresponding to the user indicative of historic user preferences in respect of items offered on sale by the offline physical retail outlets. The system further presents the user with a user-selectable list incorporating offline physical retail outlets offering user desired commodity on sale located within a predetermined distance from the current location of the electronic device based on extracted real time information and historical information.

### CROSS REFERENCE TO RELATED APPLICATIONS

Benefit is claimed under 35 U.S.C. 119(a)-(d) to Foreign application Serial No. 3625/CHE/2015 filed in India entitled “A SYSTEM AND METHOD FOR RECOMMENDING OFFLINE STORES”, filed on Jul. 15, 2015 and subsequently post-dated by two months to Sep. 15, 2015, which is herein incorporated in its entirety by reference for all purposes.

### BACKGROUND

Technical Field

The present disclosure relates to the field of interactive marketing. Particularly, the present disclosure relates to recommendation systems that recommend commodities best suitable to the requirements of the user.

Description of the Related Art

The widespread use of mobile phones and the increasing sophistication of smart phones have created societies in which personal, mobile computing power has become nearly ubiquitous leading to increasing trend of online shopping. However, even with the increased popularity of the online shopping, the e-commerce space contributes to about 5%-6% of the total worldwide retail sales, according to a well known literature survey. As evident, the prevalent choice of shopping by the user is by making a personal visit to the offline physical retail outlets commonly referred to as brick and mortar stores.

Moreover, shopping through offline physical retail outlets provide several advantages to the users over online shopping such as personally experiencing the commodity by touching/trying and the satisfaction of discovering rare finds and great bargains. For certain items (e.g., electronic goods, clothing, and the like.) the ability to try the product before purchasing is perceived as a huge benefit by many users. Sometimes, by talking directly to the retailers, the users can also negotiate to lower the price of a commodity or customize deal as per individual need. Shopping in an offline physical retail outlet additionally provides user the opportunity to personally inspect the commodity for quality.

However, one of the drawbacks associated with shopping through offline physical retail outlets is that users need to invest considerable amount of time and effort in order to find a suitable offline physical retail outlet offering the desired commodity on sale. Generically, users tend to purchase a commodity from an offline physical retail outlet that is geographically closer to the user location (for example, user's home location, and office location). Thus, the issue that often bothers the users is to find suitable offline physical retail outlets based on their shopping requirements in the vicinity of their residence/office. This results in users spending their valuable time and effort in visiting a plurality of offline physical retail outlets without actually knowing whether their shopping requirements would be satisfied at such physical retail outlets.

Further, any marketing establishment's potential sales are necessarily limited by the number of users willing to make purchases at the offline physical retail outlet. In addition, the brick and mortar retailers typically have limited resources for advertisement of the commodity and hence might fail to attract a larger number of users to the offline physical retail outlets.

Therefore, there was felt a need for a system capable of recommending offline physical retail outlets to the users in order to enhance user shopping experience. Further, there was felt a need for a system that presents the users with a list of offline physical retail outlets offering user desired commodity on sale. Further, there was felt a need for a system that facilitates the offline retailers to understand the user shopping preferences and optimize their sales channel for better revenues. Furthermore, there was felt a need for a system empowering the offline retailers to create a scope for increasing the footfall for the offline physical retail outlets which in-turn results in increased sales.

### OBJECTS

An object of the present disclosure is to recommend items available across a plurality of offline physical retail outlets, to a user.

Another object of the present disclosure is to recommend offline physical retail outlets to the users based on real time information corresponding to the user's current geo-location and shopping requirements.

One more object of the present disclosure is to extract real time information implying user intent to purchase a commodity offered on sale by at least one listed offline physical retail outlet.

Still a further object of the present disclosure is to extract historical information corresponding to user preferences in respect of items offered on sale by the offline physical retail outlets.

Yet another object of the present disclosure is to recommend offline physical retail outlets to the user in the form of a user-selectable list incorporating information corresponding to offline physical retail outlets offering user desired commodity on sale.

Still a further object of the present disclosure is to keep the user informed about the customized special offers provided by the offline physical retail outlets.

Yet another object of the present disclosure is to guide the user to a location corresponding to the offline physical retail outlets.

Yet another object of the present disclosure is to provide a real time navigation map connecting the location of the offline physical retail outlet selected by the user and the current geo-location of the user.

Yet another object of the present disclosure is to render at least one customized special offer to the user on confirmation of user presence within selected offline physical retail outlet.

Yet another object of the present disclosure is to provide the retailers with statistical and analytical data based on historical information corresponding to the user preference of the commodity.

These and other objects and advantages of the present disclosure will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof are given by way of illustration and not of limitation. Many changes and modifications may be made within the scope of the embodiments herein without departing from the spirit thereof, and the embodiments herein include all such modifications.

The embodiments cited herein envisage a system and method for recommending items to a user based on at least real time information and historic information extracted from an electronic device accessible to the user. The system comprises a database storing database entries corresponding to at least an inventory of commodities offered on sale by a plurality of predetermined offline physical retail outlets, an identifier identifying each of the offline physical retail outlets, and information corresponding to customized special offers provided by each of the offline physical retail outlets.

In accordance with the embodiments cited herein, the system further comprises a processor cooperating with the database and the electronic device. The processor is configured to:
extract the real time information corresponding to the user, the real time information indicative of user intent to purchase at least one commodity offered on sale by at least one offline physical retail outlet listed in the database, and current geo-location of the user;
extract historical information corresponding to the user, the historical information indicative of at least historic user preferences in respect of items offered on sale by the offline physical retail outlets;
trigger the database and elicit database entries relevant to at least the real time information, and present the database entries to the user in the form of a user-selectable list incorporating offline physical retail outlets offering at least the commodity on sale;
guide the user to a location corresponding to the offline physical retail outlet selected from the list;
render at least one customized special offer to the user, on confirmation of user presence within selected offline physical retail outlet; and
guide the user to the location corresponding to the offline physical retail outlet selected from the list, based on geographical coordinates indicative of the location of selected offline physical retail outlet, and further based on geographical coordinates indicative of current location of the electronic device accessible to the user.

In accordance with the embodiments cited herein, the processor is further configured to:
elicit database entries corresponding to offline physical retail outlets located within a predetermined distance from the current location of the electronic device accessible to the user and offering at least the commodity on sale;
elicit database entries corresponding to offline physical retail outlets offering commodities relevant to the historic user preferences on sale, and located within a predetermined distance from the current location of the electronic device accessible to the user;
populate the user-selectable list with elicited database entries, and trigger a display of the user selectable list, on the electronic device accessible to the user; and
confirm the presence of the user within the selected offline physical retail outlet, based on a comparison between the geographical coordinates indicative of the location of selected offline physical retail outlet and the geographical coordinates indicative of current location of the electronic device accessible to the user.

In accordance with the embodiments cited herein, the processor is still further configured to:
render the at least one customized offer on to the electronic device accessible to the user, the processor still further configured to selectively trigger the user to confirm his presence at the selected offline physical retail outlet; and
generate a real time navigation map connecting the location corresponding to the offline physical retail outlet selected from the list, and the current location of the electronic device accessible to the user, the processor further configured to trigger a display of the real time navigation map on the electronic device accessible to the user.

The embodiments cited herein envisage a method for recommending items to a user based on at least real time information and historic information corresponding to the user The method, in accordance with the embodiments cited herein comprises, storing database entries corresponding to at least an inventory of commodities offered on sale by a plurality of predetermined offline physical retail outlets, an identifier identifying each of the offline physical retail outlets, and information corresponding to customized special offers provided by each of the offline physical retail outlets, in a database; extracting the real time information and historical information corresponding to the user; eliciting database entries relevant to at least the real time information, from the database; presenting the database entries to the user in the form of a user-selectable list incorporating offline physical retail outlets offering at least the commodity on sale; guiding the user to a location corresponding to the offline physical retail outlet selected from the list; and rendering at least one customized special offer to the user, on confirmation of user presence within selected offline physical retail outlet.

In accordance with the embodiments cited herein, the step of extracting the real time information corresponding to the user further includes the step of extracting the real time information indicative of user intent to purchase at least one commodity offered on sale by at least one offline physical retail outlet listed in the database, and current geo-location of the user.

In accordance with the embodiments cited herein, the step of extracting the historical information corresponding to the user further includes the step of extracting the historical information indicative of at least historic user preferences in respect of items offered on sale by the offline physical retail outlets.

In accordance with the embodiments cited herein, the method further comprises the steps of:
guiding the user to the location corresponding to the offline physical retail outlet selected from the list, based on geographical coordinates indicative of the location of selected offline physical retail outlet, and further based on geographical coordinates indicative of current location of the electronic device accessible to the user;
eliciting database entries corresponding to offline physical retail outlets offering at least the commodity on sale and located within a predetermined distance from the current location of the electronic device accessible to the user;
eliciting database entries corresponding to offline physical retail outlets offering commodities relevant to the historic user preferences on sale, and located within a predetermined distance from the current location of the electronic device accessible to the user;
populating the user-selectable list with elicited database entries and triggering a display of the user selectable list, on the electronic device accessible to the user; and confirming the presence of the user within the selected offline physical retail outlet, based on a comparison between the geographical coordinates indicative of the location of selected offline physical retail outlet and the geographical coordinates indicative of current location of the electronic device accessible to the user.

In accordance with the embodiments cited herein, the step of confirming the presence of the user within the selected offline physical retail outlet further includes the step of selectively prompting the user to confirm his presence within the selected offline physical retail outlet, and rendering the at least one customized offer to the user subsequent to receiving a confirmation of user presence within the selected offline physical retail outlet, via the electronic device accessible to the user.

In accordance with the embodiments cited herein, the method further comprises the steps of:
generating a real time navigation map connecting the location corresponding to the offline physical retail outlet selected from the list, and the current location of the electronic device accessible to the user; and
triggering a display of the real time navigation map on the electronic device accessible to the user.

### BRIEF DESCRIPTION OF THE DRAWINGS

The embodiments cited herein and the objectives and advantages will be apparent by reading the following description in conjunction with the drawings in which:

FIG. 1 is a system level block diagram illustrating the functional blocks of the system for recommending commodities/items to a user based on at least real time information and historic information extracted from an electronic device accessible to the user, in accordance with a first embodiment of the present disclosure; and

FIG. 2 is a flow diagram illustrating the steps involved in a method for recommending commodities/items to a user based on at least real time information and historic information extracted from an electronic device accessible to the user, in accordance with a second embodiment of the present disclosure.

Although the specific features of the embodiments herein are shown in some drawings and not in others, this is done only for convenience as each feature may be combined with any or all of the other features in accordance with the embodiments cited herein.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

This disclosure is directed to, in part, providing information and recommendations to a user of an electronic device. The term ‘user’ as used throughout this specification refers to the people making use of the system envisaged by the present invention. The term ‘item’ or ‘commodity’ in this specification refers to an article of trade or commerce especially of use, advantage or value to a user. Typically, user preferences are analyzed based on historical information about the past purchases made by the user, as well as the real time information corresponding to the user, which indicate at least the user intent towards purchasing a specific commodity or a group of commodities, and the current geo-location of the user. Suitable offline physical retail outlets are suggested based on user preferences and the geo-location of the electronic device accessible to the user.

Further, the user is also provided with information about customized special offers offered by a plurality of the offline physical retail outlets. The combined analysis of geographical location of the user, and the real time information and historic information extracted from an electronic device accessible to the user, results in generation of commodity and store related recommendations relevant to the user.

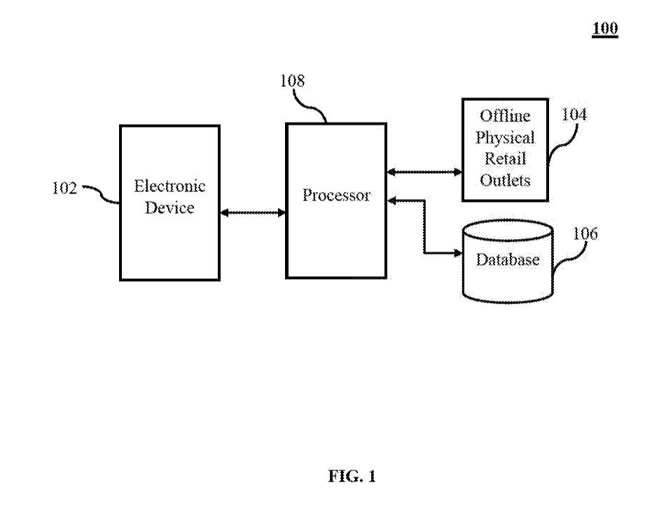

FIG. 1 illustrates the first embodiment of the present disclosure and includes a system 100 for recommending items/commodities based on at least real time information and historic information corresponding to the user. Typically, the real time information corresponding to the user is extracted from an electronic device accessible to the user, while the historic information corresponding to the user is extracted either from the electronic device accessible to the user or from a remotely located centralized server that tracks the user shopping behavior via the electronic device and derives the historic information based on the user shopping behavior.

The real time information includes at least the current geo-location of the user, and information implying user intention to purchase a particular item/commodity. The historical information corresponding to a user depicts historic user preferences (historic buying pattern, historic commodity viewing pattern, historic commodity feedback, and the like) with respect to items offered on sale by the physical offline retail outlets. The historical information is typically inferred from any past shopping activities (including browsing and buying of commodities) of the user. The historical information also includes information corresponding to the type (for example, clothing, electronics, home decor) of commodities preferred by the user. The past purchases, searched commodities, pattern of selection of commodities from categories or sub-categories are also designated as a part of the historical information, and stored in database 106.

Preferably, the real time information and historic information is integrated to from a user profile which in turn categorizes the user as belonging to predetermined reference groups. Examples of reference groups include budget user, mid-range user, premium user and super-premium user. Further, the user profile could also be categorized based on the gender of the user. Preferably, the (commodity related and physical offline store related) recommendations are made available to the user (transmitted to the electronic device accessible to the user) based on the suitability of the recommendations to the user profile. In determining the suitability of the user profile to the recommendations, at least the current geo-location of the user, and the reference group of the user, are taken into consideration.

The recommendations are generated across a plurality of commodity related categories such as clothing, footwear, electronics, stationery, food, and supermarket. Each category is preferably classified into a plurality of sub-categories. Examples of the sub-categories include, for example, men's clothing, women's clothing, and kids wear within the category ‘clothing’.

In FIG. 1, reference numeral 102 denotes an electronic device accessible to the user and capable of receiving information via the Internet. The examples of the electronic device 102 include, but are not limited to, a smart phone, a mobile phone, a laptop, a palmtop, a wearable device, a tablet computer, and a Personal Digital Assistant (PDAs). The electronic device 102 mentioned throughout this disclosure is equipped with a global positioning system or other suitable location sensing technology and hence is capable of providing specific geographic location indicative of the ‘geo-location’ of the user carrying the electronic device 102. The examples of the positioning system include Global Positioning System (GPS), Assisted GPS, Wi-Fi positioning system (WPS), Internet Protocol (IP) address based positioning and the like.

Further, the electronic device 102 comprises a user interface (not shown in figures) to offer features such as search, discovery and display of commodities available for sale at various offline physical retail outlets. Via the user interface, the user enters a search term specifying a particular commodity. Alternatively, the user interface also enables the user to browse a catalog of commodities. Any other relevant details about individual search results can also be obtained by clicking on each item from the listing. The details provided may include images of the items on sale, dimensions of the items on sale, cost, contact details of the retailers providing the items on sale and the like.

In accordance with the first embodiment, reference numeral 104 denotes a plurality of predetermined offline physical retail outlets. The system 100 identifies each of the offline physical retail outlets using a unique identifier (for example, an outlet ID, outlet name). For purposes of the present disclosure, the term “offline physical retail outlet” or “retail outlets” refers to a physical site at which a retailer (e.g., an individual, a group of individuals, or a retail corporation) offers physical products or commodities for sale. Examples of the retail outlets 104 include, but are not limited to, wholesale stores, retail stores, clothing stores, footwear stores, electronic stores, stationery stores, food stores, supermarkets, and brand stores.

In accordance with the present disclosure, the system 100 is further configured to categorize/profile the offline physical retail stores as belonging to predetermined reference groups such as, for example, budget outlet, mid-range outlet, premium outlet and super-premium outlet. The categorization of the offline physical retail outlets is typically based on at least the pricing strategy adopted by the physical offline retail stores. Preferably, the commodity related and physical offline store related recommendations are made available to the user (transmitted to the electronic device accessible to the user) based on the reference group of the offline physical retail outlets in addition to the current geo-location of the user, and the reference group of the user.

In accordance with the first embodiment, the system 100 includes a database 106 configured to store information (in the form of database entries) pertaining to the user as well as the retail outlets 104. The database entries corresponding to the user include at least the real time information and historical information. Preferably, the real time information corresponding to the user is dynamically extracted from the electronic device 102 of the user, and stored in the database 106 for further analysis. The real time information extracted from the electronic device 102 includes information implying user intention to buy a particular item/commodity, and the current geo-location of the user. Typically, the phenomenon of user specifying the name of a commodity via the user interface could be construed as the user intent of buying the said commodity. The historical information depicts historic user preferences (historic buying pattern, historic commodity viewing pattern, historic commodity feedback, and the like) with respect to items offered on sale by the retail outlets 104. Further, the database 104 also stores information indicating the reference group (budget user, mid-range user, premium user and super-premium user) the user belongs to.

The database entries corresponding to the retail outlets 104 indicate an inventory of commodities offered on sale by each retail outlet 104. The database 104 further stores information indicating the reference group (budget outlet, mid-range outlet, premium outlet and super-premium outlet) to which each of the offline retail outlets are construed to belong. The database 104 also stores the identifier identifying each retail outlet 104 and also the information corresponding to customized special offers provided by each of the retail outlets 104. Examples of the identifier associated with each retail outlet may include name of the retail outlet, reference number of the retail outlet and the like. The customized special offers preferably include suggestions, offers, promotions, and product offers tailored to individual users based on the purchase behavior of the users. The database 106 is further configured to store database entries corresponding to geographical coordinates of each retail outlet, individual layout of the retail outlet, contact details of the retail outlets, identifier identifying each item on sale and the like.

In accordance with the first embodiment, the system 100 further includes a processor 108 configured to process a user request indicating user intent to purchase an item offered on sale by at least one offline physical retail outlet 104 incorporated into the database 106. The user request indicating user intent to purchase an item can be triggered in a plurality of ways. For example, user may search for a commodity via the user interface of the electronic device 102, or otherwise the user may manually select a commodity displayed in a category or a sub-category displayed on the electronic device 102, or the user may click on a promotional offer provided by the retailer, thereby expressing his intention to purchase the said item/commodity.

The processor 108, upon receiving the request from the user, identifies the current geo-location of the user. The current geo-location of the user is identified by detecting the identifier (for example, IMEI number) of the electronic device 102 as obtained via a data communication network. The identifiers of the electronic device may also include, but are not limited to, Internet Protocol (IP) address, MAC address and the like. Subsequently, the processor 108 elicits from the database 104 the information corresponding to the reference group to which the user is designated. Further, the processor 108 optionally fetches the database entries related to the historical information depicting user preferences in respect of that specific item or any similar items offered on sale by the retail outlets.

In accordance with the first embodiment, the processor 108 is further configured to search the database 106 for the retail outlets 104 present within a predetermined distance from the current geo-location of the user, and offering the (user) desired commodity on sale. Further, the processor 108 also compares the information pertinent to the reference group corresponding to the user with the information pertinent to the reference group corresponding to the offline physical retail outlet, before generating a recommendation. For example, a ‘budget user’ is recommended only the budget retail outlets located within a predetermined distance from the user's current geo-location, while a premium user is recommended only premium offline retail outlets.

The processor 108 also compares the information corresponding to the desired commodity and the information corresponding to the inventory of items on sale at every offline physical retail outlet 104 before generating the recommendation. Subsequently, the retail outlets 104 maintaining the desired commodity as a part of their inventory are segregated based on the offline physical retail outlets' distance from the user's current geo-location and further based on the reference group corresponding to the user and each of the offline physical retail outlets. Preferably, the proximity of the offline physical retail outlet 104 from the user location is calculated by comparing the geo-location of the offline physical retail outlets 104 and the geo-location of the electronic device 102.

The number of retail outlets 104 recommended to the user by the processor 108 is determined based at least upon the current geo-location of the user, the reference groups corresponding to the user as well as the offline physical retail outlets, similarities between historic user preferences and the inventory of items on sale, similarities between the inventory offered for sale and the commodities desired by the user, availability of the commodity desired by the user. Preferably, the recommendations are transmitted to the electronic device 102 of the user in the form of SMS, email, internet messaging, phone call, native messages, and in-app messages.

The processor 108 is further configured to present a list of recommended retail outlets to the user via the user interface of the electronic device 102. The user is prompted to select at least one retail outlet 104 from the recommended list for visit. Additionally, user interface allows user to store the list of recommended retail outlets as a reference list for any further shopping requirements.

In accordance with the first embodiment, the processor 108 is still further configured to guide the user to a location corresponding to the retail outlet 104 selected from the list. The processor 108 guides the user to the location corresponding to the selected retail outlet 104 based on geographical coordinates of selected retail outlet 104 and geographical coordinates of current location of the electronic device 102.

The processor 108 is further configured to generate a real time navigation map connecting the location corresponding to the selected retail outlet 104 and the current location of the electronic device 102. As discussed in the above paragraphs, the positioning system works in conjunction with the electronic device 102 to determine the location of the user in real-time. The processor 108 is still further configured to trigger a display of the real time navigation map on the electronic device 102.

The processor 108 is still further configured to offer at least one customized special offer to the user on confirmation of user presence within selected retail outlet 104. The user presence within the selected retail outlet 104 is confirmed based on comparing the geo-location of retail outlet and that of electronic device. Additionally, the user is provided with an option to selectively indicate his presence at the selected retail outlet 104 using the electronic device 102 (by the way of sending a notification from the electronic device 102 to the system 100) to receive the customized special offer. The customized special offer could include a discount coupon or a free gift offer or a cash back offer that encourages the user to buy from the said offline physical retail outlet. The offers are customized based on several attributes associated with the user such as number of visits by the user to a specific offline physical retail outlet, and user profile. Preferably, the customized offers are conveyed to the electronic device 102 accessible to the user via at least one of SMS, email, internet message, phone call, native message, and in-app message.

In accordance with the first embodiment, the system 100 is further configured to provide offline physical retail outlet 104 related analytical and statistical data such as popularity of the retail outlets, total number of users visiting a particular retail outlet, reward points earned for each purchase, customized offers available at the said offline physical retail outlet, review of the offline physical retail outlet, review of the commodities purchased from the said offline physical retail outlet, and the like. The system 100 is further configured to provide user related analytics and statistics to the retail outlets 104 including purchase history of users, user ratings for the purchased items/commodities, user feedback on the purchased items/commodities, and the like. Preferably, the analytical and statistical data corresponding to the offline physical outlets are made available to the user in the form of customized notifications.

In accordance with the first embodiment, the user is provided with an option to mark as favourite and follow a plurality of retail outlets 104 or a particular commodity/item. Preferably, the user is also provided with periodic customized notifications incorporating information about new collections of items available at the retail outlet, current discount offers, and the like. Similarly, the periodic notification could also include a personalized message directed to the user. Further, when the user conducts a search for an unavailable commodity/item, a notification is pushed onto the electronic device 102 of the user, as soon as the desired item is made available at any of the offline physical retail outlets preferably in proximity to the current geo-location of the user. Preferably, notifications could also incorporate information corresponding to a wish list of commodities created by the user. Preferably, the physical retail outlets 104 are allowed to generate and personalize the notifications that are routed through the system 100 to the electronic device 102 accessible to the user. The customized notifications are transmitted to the electronic device 102 as at least one of an SMS, email, internet message, phone call, native message, and in-app message.

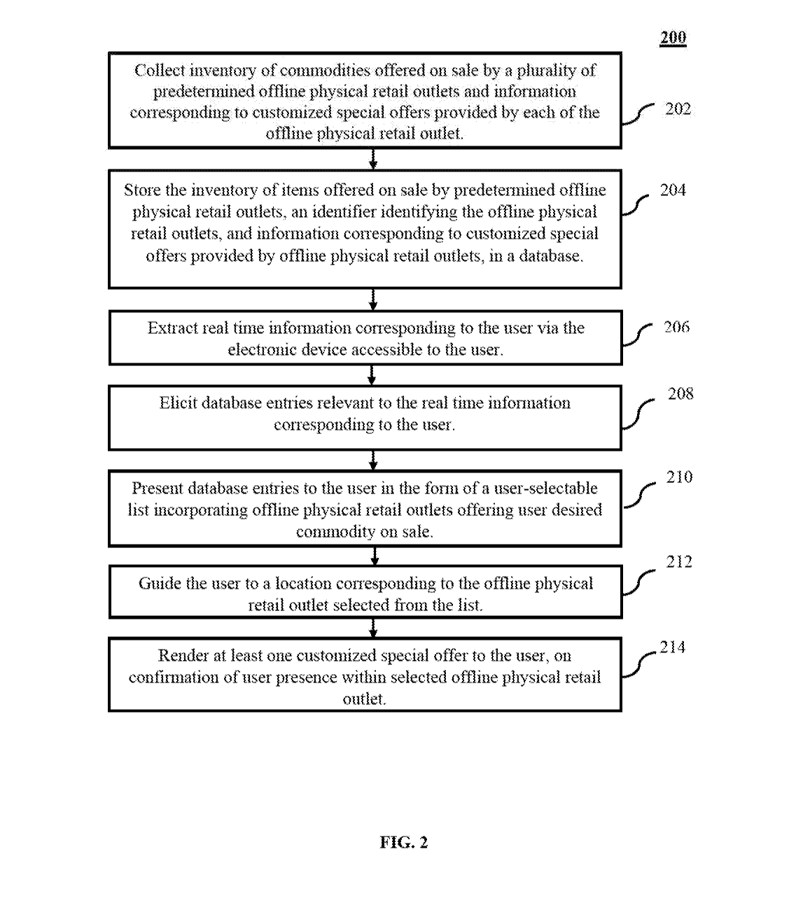

FIG. 2 illustrates the second embodiment which includes a flowchart illustrating method for recommending items to a user based on at least real time information and historic information extracted from an electronic device accessible to the user, in accordance with a second embodiment. The method, in accordance with the second embodiment comprises: storing database entries corresponding to at least an inventory of commodities offered on sale by a plurality of predetermined offline physical retail outlets, an identifier identifying each of the offline physical retail outlets, and information corresponding to customized special offers provided by each of the offline physical retail outlets, in a database (202); extracting the real time information and historical information corresponding to the user (204); eliciting database entries relevant to at least said real time information, from said database (206); presenting said database entries to the user in the form of a user-selectable list incorporating offline physical retail outlets offering at least said commodity on sale (208); guiding the user to a location corresponding to the offline physical retail outlet selected from the list (210); rendering at least one customized special offer to the user, on confirmation of user presence within selected offline physical retail outlet (212).

In accordance with the second embodiment, the step of extracting the real time information corresponding to the user further includes the step of extracting the real time information indicative of user intent to purchase at least one commodity offered on sale by at least one offline physical retail outlet listed in said database, and current geo-location of the user.

In accordance with the second embodiment, the step of extracting the historical information corresponding to the user further includes the step of extracting the historical information indicative of at least historic user preferences in respect of items offered on sale by the offline physical retail outlets.

In accordance with the second embodiment, the method further comprises the following steps:
guiding the user to the location corresponding to the offline physical retail outlet selected from the list, based on geographical coordinates indicative of the location of selected offline physical retail outlet, and further based on geographical coordinates indicative of current location of the electronic device accessible to the user;
eliciting database entries corresponding to offline physical retail outlets offering at least said commodity on sale and located within predetermined distance from the current location of the electronic device accessible to the user;
eliciting database entries corresponding to offline physical retail outlets offering commodities relevant to the historic user preferences on sale, and located within a predetermined distance from the current location of the electronic device accessible to the user;
populating said user-selectable list with elicited database entries, and triggering a display of the user selectable list, on the electronic device accessible to the user; and confirming the presence of the user within the selected offline physical retail outlet, based on a comparison between the geographical coordinates indicative of the location of selected offline physical retail outlet and the geographical coordinates indicative of current location of the electronic device accessible to the user.

In accordance with the second embodiment, the step of confirming the presence of the user within the selected offline physical retail outlet further includes the step of selectively prompting the user to confirm his presence within the selected offline physical retail outlet, and rendering the at least one customized offer to the user subsequent to receiving a confirmation of user presence within the selected offline physical retail outlet, via the electronic device accessible to the user.

In accordance with the second embodiment, the method further comprises the following steps:
generating a real time navigation map connecting the location corresponding to the offline physical retail outlet selected from the list, and the current location of the electronic device accessible to the user; and
triggering a display of said real time navigation map on the electronic device accessible to the user.

### TECHNICAL ADVANTAGES

The technical advantages envisaged by the present disclosure include the realization of a system and method that provides recommendations for items to a user based on real time information and historic information extracted from an electronic device accessible to the use. Further, the system and method envisages recommending commodities to the users based on user preferences and helps identify the offline physical retail outlet offering the desired commodity in the vicinity of user's current location. The system and method envisages offering a plurality of predetermined customized deals and offers to the user on confirming the user presence within one of the recommended offline physical retail outlet. The system and method further envisages establishing a communication channel between user and offline physical retail outlets without increased investments and a need for a website for each offline physical retail outlet.

Further, the proposed invention benefits the users by saving the user effort and time which otherwise would be spent in searching for an offline physical retail outlet offering the desired commodity on sale. One more object of the present disclosure is to guide the user to a location corresponding to the recommended offline physical retail outlet.

The proposed invention facilitates the users by providing the satisfaction of physically experiencing the commodity in an offline physical retail outlet with the advantages of electronic retailing (like searching for items, suggesting items, receiving offers and deals etc).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for recommending items to a user based on at least real time information and historic information extracted from an electronic device accessible to the user, said system comprising:
a database storing database entries corresponding to at least an inventory of commodities offered on sale by a plurality of predetermined offline physical retail outlets, an identifier identifying each of the offline physical retail outlets, and information corresponding to customized special offers provided by each of the offline physical retail outlets;
a processor cooperating with said database and said electronic device, said processor configured to:
extract the real time information corresponding to the user, said real time information indicative of user intent to purchase at least one commodity offered on sale by at least one offline physical retail outlet listed in said database, and current geo-location of the user;
extract historical information corresponding to the user, said historical information indicative of at least historic user preferences in respect of items offered on sale by the offline physical retail outlets;
said processor further configured to trigger said database and elicit database entries relevant to at least said real time information, and present said database entries to the user in the form of a user-selectable list incorporating offline physical retail outlets offering at least said commodity on sale, said processor still further configured to guide the user to a location corresponding to the offline physical retail outlet selected from the list, said processor still further configured to render at least one customized special offer to the user, on confirmation of user presence within selected offline physical retail outlet.

2. The system as claimed in claim 1, wherein said processor is further configured to:
guide the user to the location corresponding to the offline physical retail outlet selected from the list, based on geographical coordinates indicative of the location of selected offline physical retail outlet, and further based on geographical coordinates indicative of current location of the electronic device accessible to the user;
elicit database entries corresponding to offline physical retail outlets located within a predetermined distance from the current location of the electronic device accessible to the user and offering at least said commodity on sale;
elicit database entries corresponding to offline physical retail outlets offering commodities relevant to the historic user preferences on sale, and located within a predetermined distance from the current location of the electronic device accessible to the user.
populate said user-selectable list with elicited database entries, and trigger a display of the user selectable list, on the electronic device accessible to the user; and
confirm the presence of the user within the selected offline physical retail outlet, based on a comparison between the geographical coordinates indicative of the location of selected offline physical retail outlet and the geographical coordinates indicative of current location of the electronic device accessible to the user.

3. The system as claimed in claim 1, wherein said processor is further configured to render the at least one customized offer on to the electronic device accessible to the user, said processor still further configured to selectively trigger the user to confirm his presence at the selected offline physical retail outlet.

4. The system as claimed in claim 2, wherein said processor is further configured to generate a real time navigation map connecting the location corresponding to the offline physical retail outlet selected from the list, and the current location of the electronic device accessible to the user, said processor further configured to trigger a display of said real time navigation map on the electronic device accessible to the user.

5. A method for recommending items to a user based on at least real time information and historic information corresponding to the user, said method comprising the following computer implemented steps:
storing database entries corresponding to at least an inventory of commodities offered on sale by a plurality of predetermined offline physical retail outlets, an identifier identifying each of the offline physical retail outlets, and information corresponding to customized special offers provided by each of the offline physical retail outlets, in a database;
extracting the real time information and historical information corresponding to the user;
eliciting database entries relevant to at least said real time information, from said database;
presenting said database entries to the user in the form of a user-selectable list incorporating offline physical retail outlets offering at least said commodity on sale;
guiding the user to a location corresponding to the offline physical retail outlet selected from the list; and
rendering at least one customized special offer to the user, on confirmation of user presence within selected offline physical retail outlet.

6. The method as claimed in claim 5, wherein the step of extracting the real time information corresponding to the user, further includes the step of extracting the real time information indicative of user intent to purchase at least one commodity offered on sale by at least one offline physical retail outlet listed in said database, and current geo-location of the user.

7. The method as claimed in claim 5, wherein the step of extracting the historical information corresponding to the user, further includes the step of extracting the historical information indicative of at least historic user preferences in respect of items offered on sale by the offline physical retail outlets.

8. The method as claimed in claim 5, wherein the method further includes the following steps
guiding the user to the location corresponding to the offline physical retail outlet selected from the list, based on geographical coordinates indicative of the location of selected offline physical retail outlet, and further based on geographical coordinates indicative of current location of the electronic device accessible to the user;
eliciting database entries corresponding to offline physical retail outlets offering at least said commodity on sale and located within a predetermined distance from the current location of the electronic device accessible to the user;
eliciting database entries corresponding to offline physical retail outlets offering commodities relevant to the historic user preferences on sale, and located within a predetermined distance from the current location of the electronic device accessible to the user;
populating said user-selectable list with elicited database entries and triggering a display of the user selectable list, on the electronic device accessible to the user; and
confirming the presence of the user within the selected offline physical retail outlet, based on a comparison between the geographical coordinates indicative of the location of selected offline physical retail outlet and the geographical coordinates indicative of current location of the electronic device accessible to the user.

9. The method as claimed in claim 8, wherein the step of confirming the presence of the user within the selected offline physical retail outlet further includes the step of selectively prompting the user to confirm his presence within the selected offline physical retail outlet, and rendering the at least one customized offer to the user subsequent to receiving a confirmation of user presence within the selected offline physical retail outlet, via the electronic device accessible to the user.

10. The method as claimed in claim 7, wherein the method further includes the following steps:
generating a real time navigation map connecting the location corresponding to the offline physical retail outlet selected from the list, and the current location of the electronic device accessible to the user;
triggering a display of said real time navigation map on the electronic device accessible to the user.
